(19) United States
(12) Patent Application Publication
(10) Pub. No.: US 2015/0181368 A1
(43) Pub. Date: Jun. 25, 2015

(54) ELECTRONIC APPARATUS, METHOD AND STORAGE MEDIUM

(71) Applicant: Kabushiki Kaisha Toshiba, Tokyo (JP)

(72) Inventor: Nobuhide Okabayashi, Tachikawa-shi (JP)

(21) Appl. No.: 14/300,715

(22) Filed: Jun. 10, 2014

(30) Foreign Application Priority Data
Dec. 20, 2013 (JP) 2013-263796

(51) Int. Cl. H04W 4/00; H04W 52/02; H04B 7/26

(52) U.S. Cl. CPC H04W 4/008; H04B 7/26; H04W 52/0209

(57) ABSTRACT

According to one embodiment, an electronic apparatus is wearable by a user. The electronic apparatus includes a transmitter and a controller. The transmitter is configured to transmit first information to an external device when a distance between the electronic apparatus and the external device is less than a first distance. The first information relates to releasing security of the external device. The controller is configured to permit transmission of the first information to the external device when a waking state is detected, and to prohibit transmission of the first information to the external device when a sleeping state is detected.

### CROSS-REFERENCE TO RELATED APPLICATIONS

This application is based upon and claims the benefit of priority from Japanese Patent Application No. 2013-263796, filed Dec. 20, 2013, the entire contents of which are incorporated herein by reference.

### FIELD

Embodiments described herein relate generally to a security control technique.

### BACKGROUND

In recent years, various electronic apparatuses such as personal computers, tablet terminals, and smartphones have become widespread. Many such electronic apparatuses generally include some security function to prevent their being used by a person other than a valid user.

Recently, a type of electronic apparatus that is called a wearable terminal, which is worn on the human body like a wristwatch or a pair of glasses, has also appeared.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view showing the outside of an electronic apparatus according to an embodiment.

FIG. 2 is an exemplary illustration showing a system configuration of the electronic apparatus according to the embodiment.

FIG. 3 is an exemplary illustration for explaining a basic principle of security control executed by the electronic apparatus according to the embodiment.

FIG. 4 is an exemplary flowchart showing a procedure of security control executed by the electronic apparatus according to the embodiment.

### DETAILED DESCRIPTION

Various embodiments will be described hereinafter with reference to the accompanying drawings.

In general, according to one embodiment, an electronic apparatus is wearable by a user. The electronic apparatus includes a transmitter and a controller. The transmitter is configured to transmit first information to an external device when a distance between the electronic apparatus and the external device is less than a first distance. The first information relates to releasing security of the external device. The controller is configured to permit transmission of the first information to the external device when a waking state is detected, and to prohibit transmission of the first information to the external device when a sleeping state is detected.

An electronic apparatus according to the embodiment is implemented as a so-called wearable terminal, which is the type to be worn on the human body. Here, it is assumed that the electronic apparatus is implemented as a wearable terminal having the shape of a wristwatch.

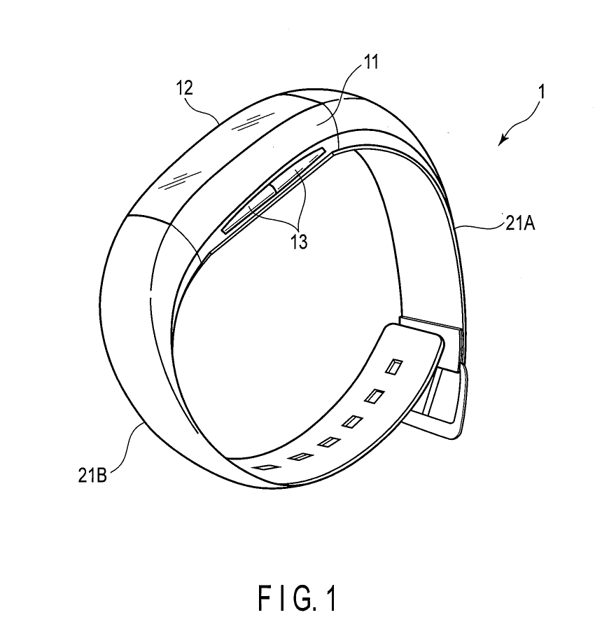

FIG. 1 is an exemplary perspective view of a wearable terminal 1. The wearable terminal 1 includes a main body 11. The main body 11 has a thin housing. In the housing, various electronic components are provided. On a top surface of the main body 11, a display 12 like a liquid crystal display (LCD) is disposed. The display 12 may be a touchscreen display which can detect a touch position on its display screen. On a side surface of the main body 11, an operation button 13 is disposed.

The wearable terminal 1 includes belts (bands) 21A and 21B for wearing the main body 11 on the human body (arm portion). The belts 21A and 21B are each implemented with a component having flexibility.

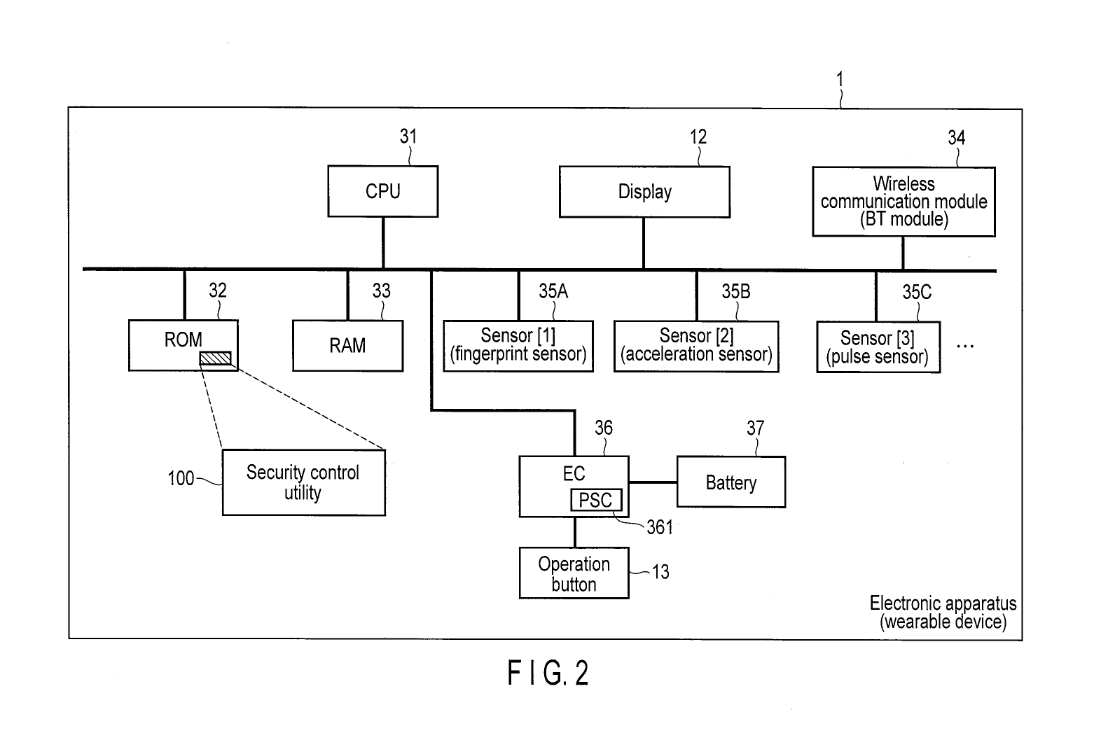

FIG. 2 is an exemplary illustration showing a system configuration of the wearable terminal 1.

As shown in FIG. 2, in addition to the display 12 and the operation button 13 shown in FIG. 1, a CPU 31, an ROM 32, an RAM 33, a wireless communication module 34, a plurality of sensors 35A, 35B, 35C, . . . , an embedded controller (EC) 36, a battery 37, and the like are disposed in the main body 11 of the wearable terminal 1.

The CPU 31 is a processor configured to control operations of various modules in the wearable terminal 1. The CPU 31 is configured to execute various programs stored in the ROM 32 using the RAM 33 as a working area. As one of the various programs, there is a security control utility program 100, which will be described later.

The wireless communication module 34 is a module configured to perform wireless communication conforming to, for example, the Bluetooth (registered trademark) standard. The plurality of sensors 35A, 35B, 35C, . . . , are, for example, a fingerprint sensor, an acceleration sensor, a pulse sensor, a geomagnetic sensor, a temperature sensor, a humidity sensor, and an illuminance sensor. Here, it is assumed that the sensor 35A is a fingerprint sensor, the sensor 35B is a three-axis acceleration sensor, and the sensor 35C is a pulse sensor. A detected value of each sensor is stored in the RAM 33, and is used by the various programs including the security control utility program 100.

The EC 36 is a single-ship microcomputer including a power supply controller (PSC) 361 configured to administer supply control of electric power of the battery 37 to the various modules in the wearable terminal 1. The EC 36 includes a function of receiving an instruction from a user by an operation of the operation button 13.

The security control utility program 100 is a program configured to provide a function of releasing security of a personal computer, a tablet terminal, a smarthphone or the like (hereinafter, referred to as an external device 2) which is owned by a user wearing the wearable terminal 1.

As described above, the wearable terminal 1 includes the fingerprint sensor 35A. A fingerprint reader of the fingerprint sensor 35A is disposed on, for example, the back surface of the main body 11, and a user can use the wearable terminal 1 by pressing the tip of a finger against the fingerprint reader to cause the fingerprint sensor 35A to read a fingerprint and causing the wearable terminal 1 to authenticate the user as a valid user.

Also, as described above, the wearable terminal 1 includes the wireless communication module 34 configured to perform wireless communication conforming to, for example, the Bluetooth (registered trademark) standard. Under Bluetooth (registered trademark), a protocol for acquiring the distance between apparatuses transmitting and receiving a wireless signal is defined. On the basis of a distance acquired by the protocol, the security control utility program 100 monitors whether or not the wearable terminal 1, which has authenticated a user as a valid user by a fingerprint read by the fingerprint sensor 35A, has approached within a predetermined distance from the external device 2 which the user owns. If it is detected that the wearable terminal 1 has approached within the predetermined distance, the security control utility program 100 transmits a release key for releasing the security of the external device 2 via wireless communication to the external device 2.

In addition, the external device 2 (whose security has been released) also monitors whether or not the wearable terminal 1 has become distant by a predetermined distance or longer on the basis of a distance acquired by the above protocol, and sets security if it is detected that the wearable terminal 1 has become distant by a predetermined distance or longer.

That is, a user can release the security of the external device 2 only by bringing the wearable terminal 1 (which has carried out authentication) closer without, for example, performing a password input on the external device 2.

In addition, as described above, the wearable terminal 1 includes the pulse sensor 35C. The pulse sensor 35C is, for example, a reflective photoelectric sensor, and is configured to measure strength and weakness of bloodstream by receiving reflected light of light emitted to a blood vessel by means of a phenomenon in which hemoglobin in blood absorbs light. A light-emitter and a light-receiver of the pulse sensor 35C are also disposed on the back surface of the main body 11. By using the pulse sensor 35C, the wearable terminal 1 acquires biometric information such as a pulse and an active state of an autonomic nerve of a user wearing the wearable terminal 1. The wearable terminal 1 is capable of, for example, recording a degree of depth of sleep on the basis of the active state of an autonomic nerve. That is, the wearable terminal 1 may remain worn on the arm portion (wrist) of a user not only during awaking but during sleeping.

Here, the case where a user wearing the wearable terminal 1 is in a sleeping state is assumed. In addition, it is assumed that the external device 2 such as a personal computer, a tablet terminal and a smartphone which the user owns is located distantly by a predetermined distance or longer from the wearable terminal 1 and its security is set.

At this time, it is assumed that a suspicious person brings the external device 2 which the user owns closer to the wearable terminal 1 which is worn by the user in a sleeping state. Then, the security of the external device 2 gets released. If the suspicious person carries out an operation on the external device 2 whose security has been released so that security will not be set even if the external device 2 becomes distant by a predetermined distance or longer from the wearable terminal 1, the external device 2 will be carried away in an available state.

Also, it is assumed that the suspicious person removes the wearable terminal 1 from the user in a sleeping state, and brings the wearable terminal 1 closer to the external device 2 which the user owns. Also in this case, the security of the external device 2 gets released. The external device 2 which is carried away with the wearable terminal 1 will be available at any time.

The wearable terminal 1 according to the embodiment includes a mechanism for preventing security release with a timing that a user does not intend and realizing security with higher reliability. This point will be hereinafter described in detail.

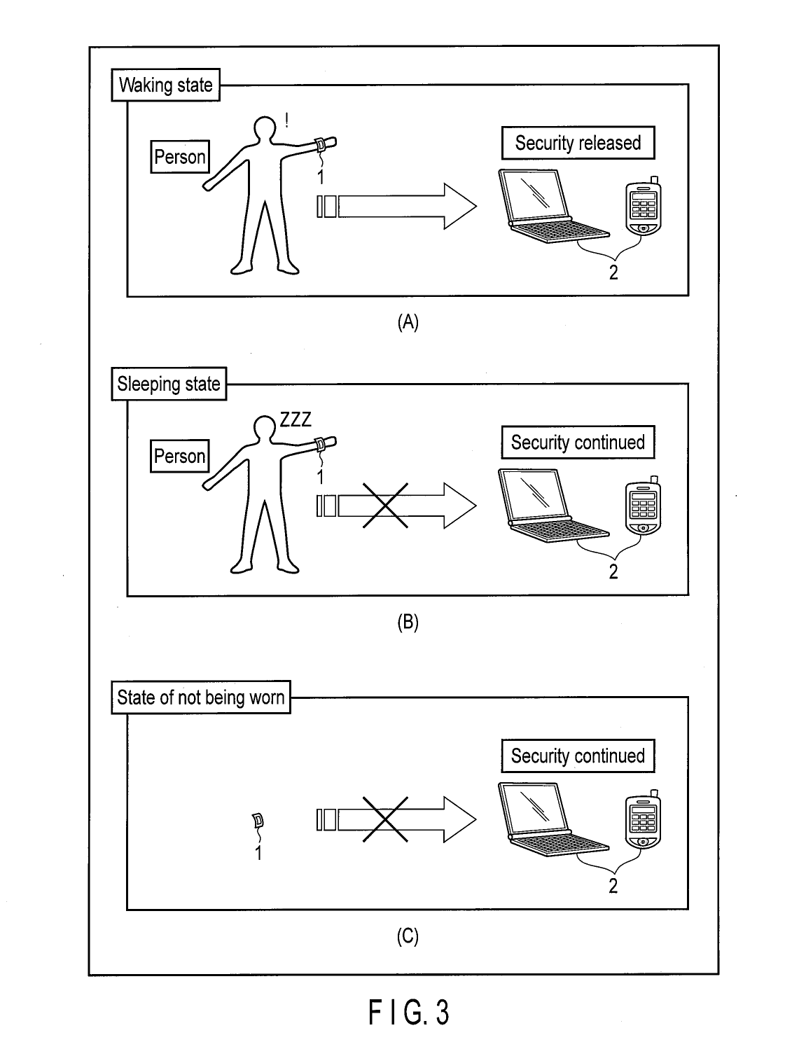

FIG. 3 is an exemplary illustration for explaining a basic principle of security control executed by the wearable terminal 1.

In FIG. 3, (A) represents the case where the wearable terminal 1 in a state of being worn by a valid user in a waking state approaches within a predetermined distance from the external device 2 which the user owns. In this case, as described above, the wearable terminal 1 (the security control utility program 100) transmits a release key for releasing the security of the external device 2 via wireless communication to the external device 2. The security of the external device 2 is thereby released.

Also, (B) represents the case where the wearable terminal 1 in a state of being worn by a valid user in a sleeping state approaches within a predetermined distance from the external device 2 which the user owns (the case where the external device 2 is brought closer to the wearable terminal 1 is assumed). In this case, the wearable terminal 1 does not carry out the above transmission of a release key to the external device 2. The security of the external device 2 is thereby continued.

For example, since a specific pattern tends to appear in the movement of an arm in a sleeping state, whether a user wearing the wearable terminal 1 is in a sleeping state or a waking state can be determined on the basis of a detected value of the acceleration sensor 35B. Also, for example, since a pulse rate tends to decline in a sleeping state as compared with that in a waking state, determination can be made on the basis of a detected value of the pulse sensor 35C. As a matter of course, determination can also be made complexly on the basis of both of a detected value of the acceleration sensor 35B and a detected value of the pulse sensor 35C. In addition, for example, since body temperature (surface temperature of the human body) tends to decline in a sleeping state as compared to that in a waking state, a detected value of a temperature sensor may also be used. Moreover, assuming that a user in a sleeping state is in an environment of small extraneous light, a detected value of an illuminance sensor can also be used secondarily. Also, a user may cause the wearable terminal 1 to recognize a transition from a waking state to a sleeping state by operating the operation button 13 when going to bed.

Moreover, (C) represents the case where the wearable terminal 1 in a state of not being worn by a valid user approaches within a predetermined distance from the external device 2 which the user owns. Also in this case, the wearable terminal 1 does not carry out the above transmission of a release key to the external device 2. The security of the external device 2 is thereby continued.

For example, if it is not detected that the wearable terminal 1 is worn on the human body (arm portion) in a predetermined time after a user is authenticated by a fingerprint read by the fingerprint sensor 35A, the wearable terminal 1 invalidates this authentication. Also, if it is detected that the wearable terminal 1 is removed from the human body (arm portion) after it is detected that the wearable terminal 1 is worn on the human body (arm portion), the wearable terminal 1 requests power-off or an authentication operation again. That is, the wearable terminal 1 can determine the states other than a state of remaining worn by a user whose identity has been confirmed as the state of not being worn by a valid user. In other words, for example, at the point of time when a suspicious person tries to remove the wearable terminal 1 from the human body (arm portion) of a user in a sleeping state, the wearable terminal 1 can invalidate a function of releasing the security of the external device 2 which the user owns.

Whether or not the wearable terminal 1 is worn on the human body (arm portion) can be determined on the basis of, for example, whether or not the amount of reflected light received by the light-receiver of light emitted from the light-emitter of the pulse sensor 35C falls within an appropriate range, that is, a detected value of the pulse sensor 35C.

Thus, the wearable terminal 1 validates a function of releasing the security of the external device 2 (if approaching within a predetermined distance) provided by the security control utility program 100, only if being worn by a valid user in a waking state, and thereby prevents security release with a timing that a user does not intend and realizes security with higher reliability. More specifically, according to the wearable terminal 1 of the embodiment, whether to transmit a release key to the external device 2 is determined appropriately by whether or not all of (a) being a valid user, (b) being in a waking state and (c) being in a worn state are satisfied.

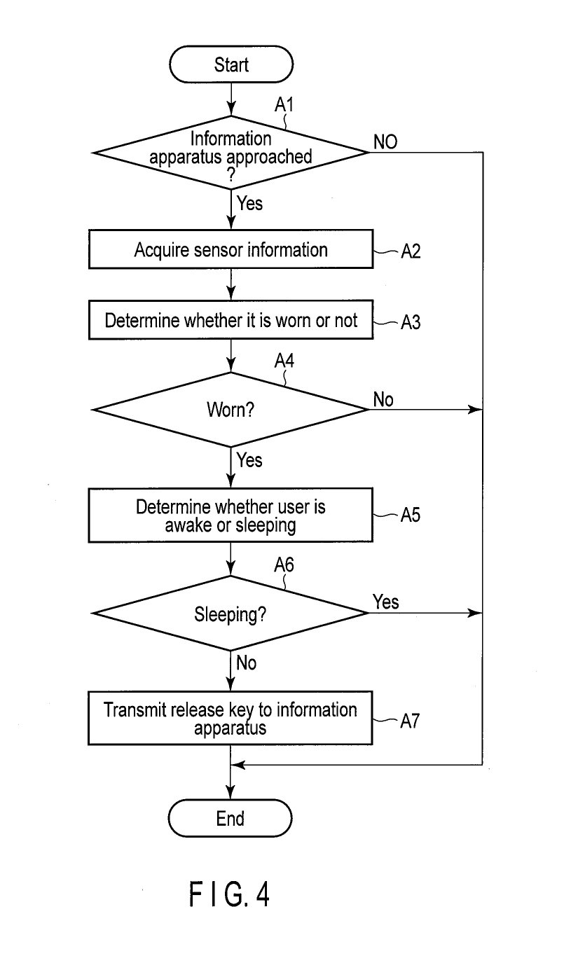

FIG. 4 is an exemplary flowchart showing a procedure of security control executed by the wearable terminal 1.

If approaching within a predetermined distance from the external device 2 which the user owns (YES in block Al), the wearable terminal 1 acquires detected values of the various sensors 35B, 35C . . . (block A2). On the basis of these detected values, the wearable terminal 1, first, examines whether or not it is in a state of being worn by a user (block A3). If it is in a state of being worn by the user (YES in block A4), the wearable terminal 1 then examines whether the user is in a waking state or a sleeping state on the basis of the above detected values (block A5).

If the user is in a waking state (NO in block A6), the wearable terminal 1 transmits a release key for releasing security to the external device 2 which the user owns and which exists within a predetermined distance via wireless communication (block A7).

As explained above, in the wearable terminal 1 according to the embodiment, security release with a timing that a user does not intend is prevented and security with higher reliability is realized.

Various processes of the present embodiment can be implemented by a computer program. Thus, the same advantages as those of the present embodiment can be easily achieved simply by installing and executing the computer program on a normal computer through a computer-readable storage medium storing the computer program.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions.

The accompanying claims and their equivalents are intended to cover such forms or modifications as would fall within the scope and spirit of the inventions.

What is claimed is:

1. An electronic apparatus wearable by a user, comprising:
a transmitter configured to transmit first information to an external device when a distance between the electronic apparatus and the external device is less than a first distance, the first information related to releasing security of the external device; and
a controller configured to:
permit transmission of the first information to the external device when a waking state is detected; and
prohibit transmission of the first information to the external device when a sleeping state is detected.

2. The apparatus of claim 1, wherein the controller is configured to:
permit transmission of the first information to the external device when a state of being worn by the user is detected; and
prohibit transmission of the first information to the external device when a state of not being worn by the user is detected.

3. The apparatus of claim 2, wherein the controller is configured to:
permit transmission of the first information to the external device when the user being a valid user is detected; and
prohibit transmission of the first information to the external device when the user being not a valid user is detected.

4. The apparatus of claim 1, wherein the transmitter is configured to restrain the transmission of the first information to the external device when a distance between the electronic apparatus and the external device is greater than the first distance.

5. The apparatus of claim 1, wherein the controller is configured to detect whether the user is in a waking state or a sleeping state based on a detected value of at least one of an acceleration sensor and a pulse sensor.

6. A method of an electronic apparatus wearable by a user comprising a transmitter configured to transmit first information to an external device when a distance between the electronic apparatus and the external device is less than a first distance, the first information related to releasing security of the external device, the method comprising:
permitting transmission of the first information to the external device when a waking state is detected; and
prohibiting transmission of the first information to the external device when a sleeping state is detected.

7. The method of claim 6, wherein:
the permitting comprises permitting transmission of the first information to the external device when a state of being worn by the user is detected; and
the prohibiting comprises prohibiting transmission of the first information to the external device when a state of being not worn by the user is detected.

8. The method of claim 7, wherein:
the permitting comprises permitting transmission of the first information to the external device when the user being a valid user is detected; and
prohibiting comprises prohibiting transmission of the first information to the external device when the user being not a valid user is detected.

9. The method of claim 6, further comprising restraining the transmission of the first information to the external device when a distance between the electronic apparatus and the external device is greater than the first distance.

10. The method according to claim 6, wherein the permitting or the prohibiting comprises detecting whether the user is in a waking state or a sleeping state based on a detected value of at least one of an acceleration sensor and a pulse sensor.

11. A computer-readable, non-transitory storage medium having stored thereon a computer program which is executable by a computer wearable by a user, the computer program controlling the computer to function as:
a transmitter configured to transmit first information to an external device when a distance between the computer and the external device is less than a first distance, the first information related to releasing security of the external device; and
a controller configured to:
permit transmission of the first information to the external device when a waking state is detected; and
prohibit transmission of the first information to the external device when a sleeping state is detected.

12. The medium of claim 11, wherein the controller is configured to:
permit transmission of the first information to the external device when a state of being worn by the user is detected; and
prohibit transmission of the first information to the external device when a state of being not worn by the user is detected.

13. The medium of claim 12, wherein the controller is configured to:
permit transmission of the first information to the external device when the user being a valid user is detected; and
prohibit transmission of the first information to the external device when the user being not a valid user is detected.

14. The medium of claim 11, wherein the transmitter is configured to restrain the transmission of the first information to the external device when a distance between the computer and the external device is greater than the first distance.

15. The medium of claim 11, wherein the controller is configured to detect whether the user is in a waking state or a sleeping state based on a detected value of at least one of an acceleration sensor and a pulse sensor. *
